(19) United States
(12) Patent Application Publication
(10) Pub. No.: US 2010/0266446 A1
(43) Pub. Date: Oct. 21, 2010

(54) HANDS AND FOREARMS SANITIZER

(75) Inventor: Jimmy Constantacos, Westmount (CA)

Correspondence Address: GOWLING, LAFLEUR AND HENDERSON LLP, 1. PLACE VILLE-MARIE, 37TH FLOOR, MONTREAL, QC, CA

(73) Assignee: Mr.Jimmy Constantacos, Westmount (CA)

(21) Appl. No.: 12/426,712

(22) Filed: Apr. 20, 2009

(51) Int. Cl. C01B 13/11; B01J 7/00; G05B 1/01; G05B 17/02; G05B 9/00

(52) U.S. Cl. 422/24; 422/305; 422/105; 422/107; 422/116; 422/117

(57) ABSTRACT

A hand sanitizer having first and second compartments in which the first compartment includes an access permitting user's hands and forearms to be inserted and an ozone generator for sanitizing the hands. The second compartment houses an ultraviolet source for converting ozone present in said second compartment into molecular oxygen and includes also an access permitting user's hands and forearms to be inserted. The ozone concentration in the first compartment is maintained at a predetermined level.

### CROSS REFERENCE TO RELATED APPLICATIONS

This is the first application filed for the present invention.

### TECHNICAL FIELD

The present invention generally relates to a method and apparatus for sanitizing hands. In particular, the present invention pertains to a method and apparatus for removing contaminants from hands using ozone and an ultraviolet source to neutralize the harmful residual ozone on the user's hands, to thereby sterilize the hand.

### BACKGROUND

According to the Centers for Disease Control and Prevention, hand washing is the single most important prevention step for reducing disease transmission. In healthcare settings, hand washing can prevent potentially fatal infections from spreading from patient to patient and from patient to healthcare worker and vice-versa. The basic rule in the hospital is to cleanse hands before and after each patient contact by either washing hands with an anti-bacterial soap or gel, or using an alcohol-based hand rub. In observational studies conducted in hospitals, healthcare workers washed their hands an average of five times per shift to as many as 30 times per shift; certain nurses washed their hands ≦100 times per shift. The duration of hand washing or hygienic hand-wash episodes by healthcare workers has averaged 6.6-24.0 seconds in observational studies which is insufficient to kill harmful bacteria that can be transmitted to patients. In addition to washing their hands for limited time periods, personnel often fail to cover all surfaces of their hands and fingers.

According to the Virginia Department of Agriculture and Consumer Services, hand washing is one of the most important ways to prevent food borne illnesses. Food handling statistics show that over half of food borne disease outbreaks are related to restaurants as opposed to food consumed at home or at school. In many cases, the source of the disease-causing pathogen is a food service worker that has been suffering with illness caused by food borne bacteria or viruses. The hands that are doing the food handling are often the vehicle that transmits the bacteria and viruses from the sick worker to the food. When this contamination involves foods that are ready-to-eat, a food borne illness outbreak can occur. Food service workers are mandated by law to wash their hands after use of a restroom in order to prevent transmission of infectious diseases to food service customers. However, because the restrooms are private, the regulations requiring hand washing are nearly unenforceable. Concern for public safety has become greater as new pathogens and food hazards emerge.

Routine use of anti-bacterial soap or gel or alcohol-based hand rub may cause chapping of the skin or other undesirable reactions, especially for those persons who are sensitive to the active ingredients found in these products. Thus a need remains for a disinfectant that may be used quickly and conveniently to kill harmful bacteria and viruses.

The prior art attempts to obviate the aforementioned problems by exposing hands to ozone and/or UV radiation.

Ozone is a well known oxidant gas that destroys bacteria, viruses and other microorganisms on contact. Contaminants which come in contact with ozone are ruptured in a process known as cell lysing. Ozone is therefore very effective for sterilizing and disinfecting and it is remarkably superior to other germicides and disinfectants in its strong sterilizing and disinfecting power due to its rapid active oxidation power. Accordingly, such sterilizing and disinfecting power of ozone is very advantageous.

Accordingly, some solutions have been provided in the prior art to sanitize hands with ozone. For example, hands immersed in ozone and subsequently in UV radiation is taught in some patents.

In U.S. Pat. No. 6,254,625, granted to Rosenthal and Rosenthal in July 2001, a hand sanitizer is provided using ozone and a germicidal ultraviolet source. The hands are inserted in a chamber containing a series of lamps which are sequentially operated within the chamber. An ultraviolet light is first used to produce ozone (wavelengths less than 184 nm) which circulates through the unit and about the hands, oxidizing pathogens, detritus or debris that may be embedded on the hands. During this period, a UVC light having a germicidal wavelength (254 nm) is used for inactivation of pathogenic organisms resident on the skin surface. While the hands remain in the same chamber, a third UV light (300 nm) is used to convert the excess ozone back into molecular oxygen after the sanitation treatment. As the hands are exposed to sequentially UV lights, a high efficacy quartz halogen lamp is next used for protecting the hands from any undesirable effects of the UV light on the user's skin (photoreactivation). In addition to the harmful effect of the sequentially UV radiation exposition, the generated ozone is destroyed upon UV radiation. Therefore, the required ozone concentration must be regenerated before a second user may use the apparatus.

PCT International Publication No WO2000/06209 (published in February 2000) describes a hand sanitizer housing an ozone-generating radiation source in a soaking chamber and a germicidal chamber containing a UV source wherein the hands are sterilized. A fan is disposed proximate to the ozone generator to direct an air stream in the soaking chamber. The ozone flows with the air stream and exists the soaking chamber to enter the germicidal chamber toward the hands. The germicidal radiation source is initiated subsequent to expiration of ozone generation interval to expose hands to remove bacteria. The germicidal radiation further serves as a catalyst for the produced ozone to facilitate enhanced removal of odor from the hands. Once in the germicidal chamber, the ozone is converted back to oxygen upon germicidal radiation. Therefore, the required ozone concentration must be generated after every single use.

In both U.S. Pat. No. 6,254,625 and WO2000/06209, the regeneration of ozone is both energy inefficient and time-consuming which is unsuitable with the requirements of this application. Hands sanitizing must be performed in a very short period of time. Therefore, it is desired to overcome or reduce at least some of the above-described drawbacks.

### SUMMARY OF THE INVENTION

In a broad sense, the present invention concerns a hands and forearms sanitizer containing first and second compartments. The first compartment has an access permitting user's hands and forearms to be inserted into the first compartment which contains an ozone generator. The second compartment includes an access permitting user's hands and forearms to be inserted and an ultraviolet generating source in order to convert ozone present in the second compartment into molecular oxygen.

In a first embodiment the hands and forearms sanitizer further comprises an ozone control system for maintaining the ozone concentration in the first compartment at a predetermined level. The present invention therefore allows a user to use the hands and forearms sanitizer instantly since the ozone concentration is always maintained at the required level in order to sanitize the hands and the forearms. The ozone concentration in the first compartment is maintained between 0.1 ppm and 200 ppm.

In a second embodiment, there is provided an ozone sensor controller in order to energize a control circuit for activating the ozone generator upon detection of ozone concentration in the first compartment.

In a third embodiment, the ozone control system comprises a motion detector housed in the second compartment for energizing a control circuit for activating a timer, which activates a control circuit. The control circuit activates the ozone generator in the first compartment upon a predetermined number of uses.

In a fourth embodiment the hands and forearms sanitizer comprises a motion detector energizing a control circuit for activating the ultraviolet generator upon sensing motion in the second compartment.

In a fifth embodiment, the second compartment contains an ultraviolet (UV) source having a wavelength of between 200 nm and 290 nm and more particularly a wavelength of 254 nm.

In another embodiment, the ozone generator in the first compartment is a corona discharge cell.

Alternatively, the ozone generator in the first compartment is an ultraviolet source having wavelengths of between 150 nm and 200 nm.

According to another embodiment of the invention, there is provided in the first and second compartment of the hands and forearms sanitizer, arm holes in order to introduce the arms and the hands in the compartments.

According to another embodiment, the first compartment contains a fan in order to equalize the produced ozone within the first compartment.

According to another embodiment of the invention, there is provided a method for sanitizing hands and forearms comprising the steps of 1) producing ozone in a first compartment, 2) producing ultraviolet radiation in a second compartment, 3) exposing hands and forearms to the ozone in order to remove contaminants from the hands and the forearms and 4) exposing hands and forearms to the ultraviolet radiation in order to convert excess ozone into molecular oxygen which is any ozone that has not been utilized for removing contaminants on the hands and the forearms and any ozone escaping from the first compartment.

In another embodiment of the invention, the method for sanitizing hands and forearms comprises the step of maintaining a constant ozone concentration in the first compartment between 0.1 ppm and 200 ppm.

In another embodiment of the invention, the method for sanitizing hands and forearms comprises an ultraviolet radiation source having wavelengths of between 200 nm and 290 nm.

In another embodiment, the ozone is produced using a UV source.

Alternatively, the ozone is produced using a corona discharge cell.

### Definitions

Unless otherwise specified, the following definitions apply: The singular forms “a”, “an” and “the” include corresponding plural references unless the context clearly dictates otherwise. As used herein, the term “comprising” is intended to mean that the list of elements following the word “comprising” are required or mandatory but that other elements are optional and may or may not be present As used herein, the term “consisting of” is intended to mean including and limited to whatever follows the phrase “consisting of”. Thus the phrase “consisting of” indicates that the listed elements are required or mandatory and that no other elements may be present.

An embodiment of the present invention will now be described by way of example with reference to the accompanying drawings. It is noted, however, that the appended drawings illustrate only typical embodiments of this invention and are therefore not to be considered limiting of its scope, for the invention may admit to other equally effective embodiments.

### BRIEF DESCRIPTION OF THE DRAWING

FIG. 1 is a perspective view of a hands and forearms sanitizer in accordance with an embodiment of the present invention which is suitable for performing a method for sanitizing hands and forearms in accordance with other embodiments of the invention.

FIG. 2 is a cross-sectional side view of a hands and forearms sanitizer in accordance with an embodiment of the present invention.

FIG. 3 is a cross sectional top view of a hands and forearms sanitizer in accordance with an embodiment of the present invention.

FIG. 4 is an elevation front view of a hands and forearms sanitizer in accordance with an embodiment of the present invention.

FIG. 5 is a partial cross sectional view of a hands and forearms sanitizer in accordance with an embodiment of the present invention.

FIG. 6 is a cross sectional rear view of a hands and forearms sanitizer in accordance with an embodiment of the present invention.

### DETAILED DESCRIPTION

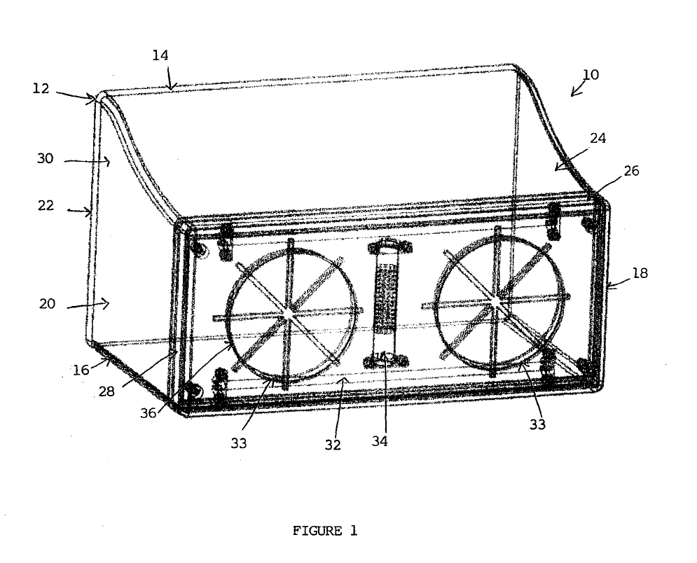

Turning now to FIG. 1, a hands and forearms sanitizer 10 in accordance with an embodiment of the present invention is shown in perspective view to more clearly illustrate the components thereof. The hands and forearms sanitizer 10 comprises a housing 12 having top and bottom panels 14 and 16 respectively, front and rear panels 18 and 20 respectively, and side panels 22 and 24. The housing 12 is formed of materials resistant to ozone oxidation, such as Teflon™, PVC, ethylene propylene diene M-class rubber (EPDM), stainless steel or other like materials. While any suitable size may be utilized, the hands and forearms sanitizer 10 may have an overall size of 12″×12″×12″ (or 30 cm×30 cm×30 cm), for example. The housing 12 may include a handle for conveniently transporting the hands and forearms sanitizer 10. A panel 26 divides the housing 12 into two compartments. The dividing panel 26 is formed of materials resistant to ozone oxidation, such as Teflon™, PVC, ethylene propylene diene M-class rubber (EPDM), stainless steel or other like materials. The second compartment 28 defines an enclosed space which houses the UV source 32. More particularly, the source 32 may be for example a 5-250 Watt ultraviolet lamp. The first compartment 30 defines an enclosed space housing the operating components of the hands and forearms sanitizer 10 which include the ozone generator 34. The ozone generator 34 may be a UV source or a corona discharge cell. More particularly, the UV source may be for example a 5-250 Watt and the corona discharge cell may be for example of a strength of 1 mg/h to 20 g/h of ozone depending on the size of the hands and forearms sanitizer.

The front panel 18 and the dividing panel 26 are adapted for receiving hands and forearms of a user of the hands and forearms sanitizer 10. The arm holes 36 of the dividing panel 26 are partially sealed off to prevent ozone escaping from the first compartment 30 to the second compartment 28. The arm holes 36 thus define an access through which the hands and forearms are inserted. These arm holes 36 may include a rubberized cover, seal, curtain, or equivalent that displaces or opens when the user pushes his or her hands through the holes but which remains tightly sealed around the forearms to limit the escape of ozone from the sanitizer. In addition the arm holes 33 of the front panel 18 are partially sealed off to inhibit ozone, that could be present in the second compartment 28, from escaping into the environment surrounding the hands and forearms sanitizer 10. The arm holes 36 and 33 are made of a resilient material to ensure a tight fit, for example EPDM. It is noted that the size of the hands and forearms sanitizer 10 depends on the number of arm holes. A hands and forearms sanitizer may have two arm holes, or four arm holes, six arm holes, etc. for sanitizing the hands and forearms of multiple users in parallel. It should also be understood that, depending on its size, the hands and forearms sanitizer may only be able to sanitize a portion of the forearms, or just the hands and wrists, or just the hands.

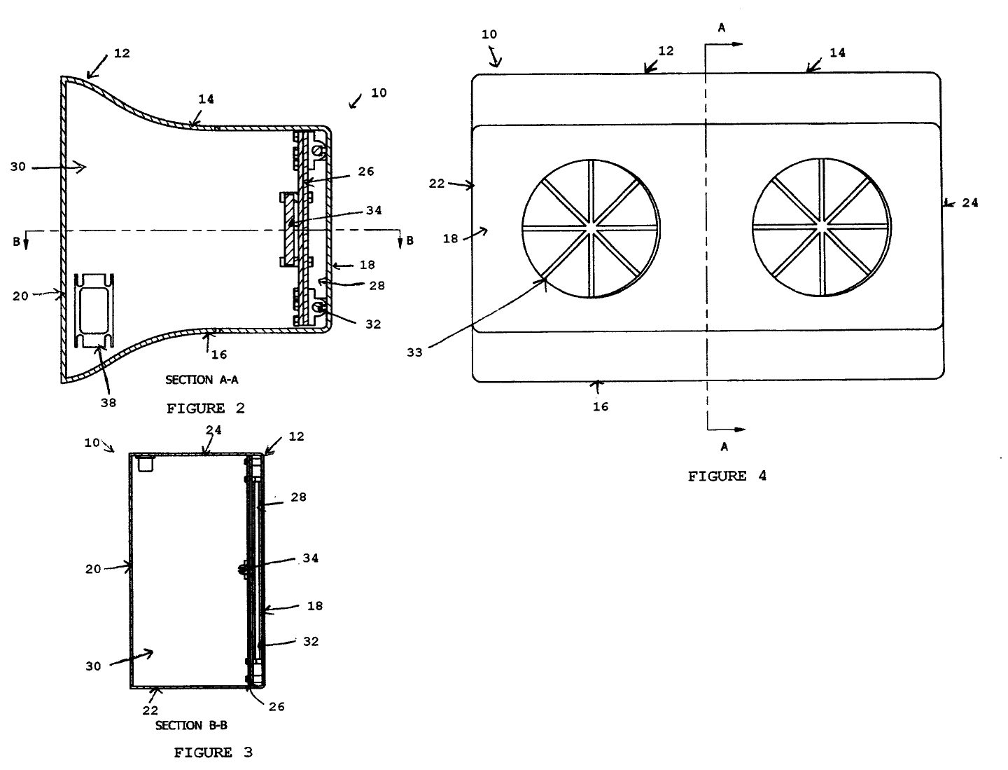

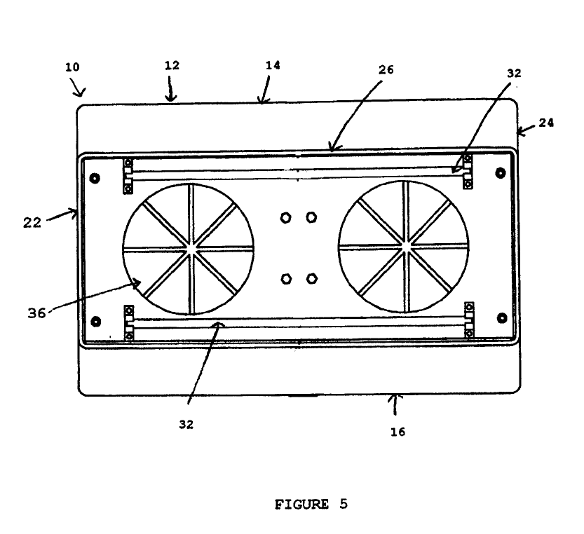

Referring now to FIG. 2, the hands and forearms sanitizer 10 of the invention includes a power supply 38 which in one embodiment may be housed in the first compartment 30 or in the second compartment 28. FIG. 2 is a cross-sectional view taken through section A-A in FIG. 4.

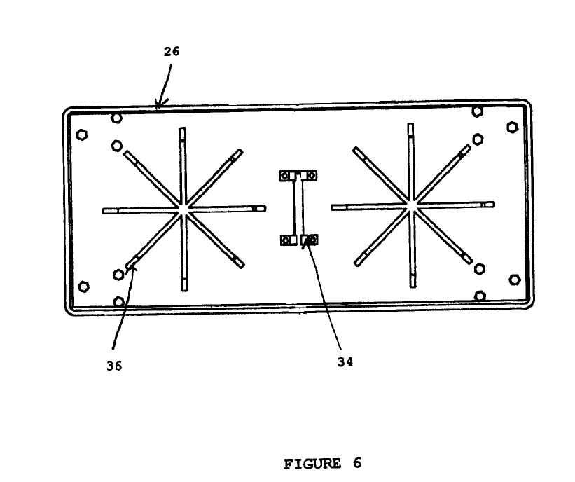

FIG. 3, 4, 5 and 6 show different views of the same hands and forearms sanitizer. In particular, FIG. 3 is a cross-sectional view taken through section B-B in FIG. 2. FIGS. 2-4 show the configuration of the components in one particular embodiment. FIG. 5 and FIG. 6 show other embodiments of the sanitizer, which are also presented by way of example.

It should now be appreciated that a method for sanitizing hands and forearms in accordance with the present invention may comprise a step of producing ozone either by radiation of UV light into atmospheric gas having wavelengths of less than 180 nm or by a corona discharge cell, in order to ionize the atmospheric gas and oxidizing organic matter on the surface and subsurface of the hands and the forearms with the produced ozone by exposing hands and forearms in the produced ozone for a period of time which depends on the ozone concentration in the first compartment and long enough for oxidizing the detritus or other debris and inactivating most bacterial pathogens and viruses. Advantageously, the ozone will oxidize debris embedded beneath fingernails. A light, sound or other indicator may be provided to notify the user when to remove his hands. Additional steps include retracting the hands and forearms from the ozonated environment (first compartment) and exposing the hands and the forearms to a UV light radiated compartment (second compartment) in order to convert excess ozone to molecular oxygen, said excess ozone being any of the produced ozone that has not been utilized for oxidation of the organic matter and any ozone that could have escaped from the ozonated compartment. The UV light in the second compartment has a wavelength of about 254 nm at the hands. The user continues to withdraw his hands and forearms from the second compartment until they are outside of the hands and forearms sanitizer. The hands and forearms are thus sanitized and free of ozone. The amount of time that the hands and forearms should remain in the second compartment may vary. In one embodiment, the hands and forearms can be simply withdrawn through the second compartment without having to stop or linger in the second compartment.

The effectiveness of the present invention relies on maintaining a constant ozone concentration of about 0.01 ppm to 200 ppm in the first compartment 30. An ozone sensor could be present in the first compartment 30 in order to maintain the required ozone concentration. A suitable ozone sensor may be for example an Eco sensor OS-4. A timer could also be suitable to maintain a constant ozone concentration in the first compartment 30 and be programmable according to the number of uses. Therefore, a sensor, for example an infrared sensor, or other type of sensor, may be provided for detecting the insertion of a person's hands and forearms. By maintaining the ozone concentration constant in the first compartment 30, the hands and forearms sanitizer 10 is ready to use instantly, no waiting period is required to reach the required ozone concentration to sanitize the hands and the forearms. A fan (not shown) could be provided in the first compartment 30 in order to equalize the produced ozone. The UV source 32 in the second compartment 28 may be activated upon hands insertion in the second compartment 28. In another embodiment, the UV source 32 remains on continuously, therefore no sensor is needed.

The hands and forearms sanitizer 10 houses two compartments, the first compartment 30 wherein the ozone is produced to sanitize the hands and the forearms and the second compartment 28 wherein the UV source 32 irradiates in order to convert the excess ozone to molecular oxygen. This novel hands and forearms sanitizer configuration allows the isolation of the produced ozone and the UV source irradiation preventing the conversion of the produced ozone in the first compartment 30 to molecular oxygen by radiation of the UV source 32. Therefore, the produced ozone is maintained at the required concentration enabling a second or subsequent use instantly. In addition, maintaining a constant required ozone concentration is more energy efficient and therefore less costly to operate.

In the preferred embodiment of the invention described above, disinfecting the hands and forearms of health care workers has been described for illustrative purposes. One can thus easily appreciate that the above described embodiments of the hands and forearms sanitizer according to the present invention obviates the limitations and drawbacks of the prior art devices, namely by improving energy efficiency, rapidity of use and by minimizing production costs, thus enabling safe and convenient use in a wide range of applications.

Although the present invention has been described hereinabove by way of preferred embodiments thereof, it can be modified without departing from the spirit and nature of the subject invention as defined in the appended claims. Although the hands and forearms sanitizer has been described as sanitizing hands and forearms, it can be configured for disinfecting other parts of the body as may required. For example, the hands and forearms sanitizer 10 may be configured to accept a foot or a leg of a person to be exposed to ozone for destroying bacteria, viruses and other microorganisms. In addition, the hands and forearms sanitizer 10 may be configured to accept objects such as shoes, toys or toothbrushes for sterilization.

What is claimed:

1. A hands and forearms sanitizer comprising:
a) a housing containing first and second compartments;
b) said first compartment including an access permitting user's hands and forearms to be inserted into said first compartment;
c) an ozone generator housed in said first compartment of said housing;
d) said second compartment including an access permitting user's hands and forearms to be inserted into said second compartment; and
e) an ultraviolet generating source housed in said second compartment of said housing, for converting ozone present in said second compartment into molecular oxygen.

2. A hands and forearms sanitizer as claimed in claim 1 further comprising an ozone control system for maintaining ozone concentration in said first compartment at a predetermined level.

3. The hands and forearms sanitizer as claimed in claim 2 wherein said ozone control system includes an ozone sensor housed in said first compartment for energizing a control circuit for activating said ozone generator upon ozone concentration detection in said first compartment.

4. The hands and forearms sanitizer as claimed in claim 2 wherein said ozone control system includes a motion detector for energizing a control circuit for activating a timer, said timer activating a control circuit for activating the ozone generator in said first compartment upon a predetermined number of uses.

5. The hands and forearms sanitizer as claimed in claim 1 further comprising a motion detector for energizing a control circuit for activating said ultraviolet generator upon sensing motion in said second compartment.

6. The hands and forearms sanitizer as claimed in claim 5, wherein said ultraviolet (UV) generator is a UV source which has wavelengths of between 200 nm and 290 nm.

7. The hands and forearms sanitizer as claimed in claim 6, wherein said UV source has a wavelength of 254 nm.

8. The hands and forearms sanitizer as claimed in claim 1 wherein said ozone generator is a corona discharge cell.

9. The hands and forearms sanitizer as claimed in claim 1 wherein said ozone generator is an ultraviolet source.

10. The hands and forearms sanitizer as claimed in claim 9 wherein said ultraviolet source has wavelengths of between 150 nm and 180 nm.

11. The hands and forearms sanitizer as claimed in claim 2 wherein the ozone concentration is maintained between 0.1 ppm and 200 ppm.

12. The hands and forearms sanitizer as claimed in claim 3 wherein the ozone concentration is maintained between 0.1 ppm and 200 ppm.

13. The hands and forearms sanitizer as claimed in claim 1 wherein said access comprises arm holes formed in a front panel of each of said first and second compartments.

14. The hands and forearms sanitizer as claimed in claim 1 further comprising a fan in said first compartment.

15. A method for sanitizing hands and forearms, said method comprising the steps of:
producing ozone in a first compartment;
producing ultraviolet radiation in a second compartment;
exposing hands and forearms to the ozone in order to remove contaminants from the hands and the forearms; and
exposing hands and forearms to the ultraviolet radiation in order to convert excess ozone into molecular oxygen, said excess ozone being any of the ozone that has not being utilized for removing contaminants on the hands and the forearms and any ozone escaping from the first compartment.

16. The method for sanitizing hands and forearms as claimed in claim 15 further comprising the step of maintaining a constant ozone concentration in said first compartment.

17. The method for sanitizing hands and forearms as claimed in claim 15 wherein the ozone concentration is maintained between 0.1 ppm and 200 ppm.

18. The method for sanitizing hands and forearms as claimed in claim 15 wherein the ultraviolet radiation has wavelengths of between 200 nm and 290 nm.

19. The method for sanitizing hands and forearms as claimed in claim 15 wherein producing ozone is performed using a corona discharge cell.

20. The method for sanitizing hands and forearms as claimed in claim 15 wherein producing ozone is performed using an ultraviolet source.
